(19) United States
(12) Patent Application Publication
(10) Pub. No.: US 2007/0168735 A1
(43) Pub. Date: Jul. 19, 2007

(54) SYSTEM AND METHOD FOR AUTOMATIC TESTING

(75) Inventors: YI LO, Tu-Cheng (TW); YI-TSAI CHEN, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,416

(22) Filed: Aug. 4, 2006

(30) Foreign Application Priority Data
Nov. 4, 2005 (TW) 94138771

(51) Int. Cl. G06F 11/00

(52) U.S. Cl. 714/33

(57) ABSTRACT

An automatic testing system (100) for testing an electronic device (300) includes a testing plan module (130), a testing storage and management module (120), a testing script generating module (140), and an automatic testing module (110). The testing plan module is used for receiving a testing plan. The testing storage and management module is used for saving the testing plan. The testing script generating module is used for generating testing scripts according to the testing plan, and for saving the testing scripts in the testing storage and management module. The automatic testing module is used for reading at least one testing script saved in the testing storage and management module, for automatically testing the electronic device, for receiving test data from the electronic device, and for saving the test data in the testing storage and management module. An automatic testing method for testing the electronic device is also provided.

### 1. FIELD OF THE INVENTION

The present invention relates to systems and methods for testing electronic devices, and specifically to a system and method for automatically testing electronic devices.

### 2. DESCRIPTION OF RELATED ART

Electronic devices must be inspected and tested before being shipped out of the factory, to make sure that the electronic devices function normally. Conventionally, a testing system inspects and tests the electronic devices. According to a specification of an electronic device under testing, the testing system generates a testing plan in a form of word or text documents. Then the testing system generates testing scripts according to the testing plan. Generally, the testing scripts must be chosen to be read and run one by one when testing the electronic devices. After testing is done, test results are manually input into the testing system by an engineer or operator.

Current testing systems can only read one testing script at a time. In a testing procedure, however, a lot of testing scripts need to be run, the tester must choose the testing scripts and input the test results on many occasions. Thus, the conventional testing system is inefficient.

Therefore, a heretofore unaddressed need exists in the industry to overcome the aforementioned deficiencies and inadequacies.

### SUMMARY OF INVENTION

An exemplary embodiment of the present invention provides an automatic testing system. The automatic testing system is used for testing an electronic device, and includes a testing plan module, a testing storage and management module, a testing script generating module, and an automatic testing module. The testing plan module receives a testing plan. The testing storage and management module saves and manages the testing plan. The testing script generating module generates testing scripts according to the testing plan, and saves the testing scripts in the testing storage and management module. The automatic testing module reads at least one testing script saved in the testing storage and management module, for automatically testing the electronic device, for receiving test data from the electronic device, and for saving the test data in the testing storage and management module.

Another exemplary embodiment of the present invention provides an automatic testing method for testing an electronic device. The automatic testing method includes steps of: receiving a testing plan, and automatically saving the testing plan in a testing storage and management module; generating corresponding testing scripts, and saving the testing scripts in the testing storage and management module; reading at least one testing script from the testing storage and management module; testing the electronic device based on the testing script; and receiving test data from the electronic device, and saving the test data in the testing storage and management module.

Other advantages and novel features will become more apparent from the following detailed description when taken in conjunction with the accompanying drawings, in which:

### BRIEF DESCRIPTION OF DRAWINGS

FIG. 1 is a block diagram of an automatic testing system of an exemplary embodiment of the present invention;

FIG. 2 is a block diagram of a testing storage and management module of the automatic testing system of another exemplary embodiment of the present invention;

FIG. 3 is a block diagram of a testing storage and management module of the automatic testing system of yet another exemplary embodiment of the present invention;

FIG. 4 is a flowchart of an automatic testing method of a further exemplary embodiment of the present invention; and

FIG. 5 is a flowchart of an automatic testing method of a still further exemplary embodiment of the present invention.

### DETAILED DESCRIPTION

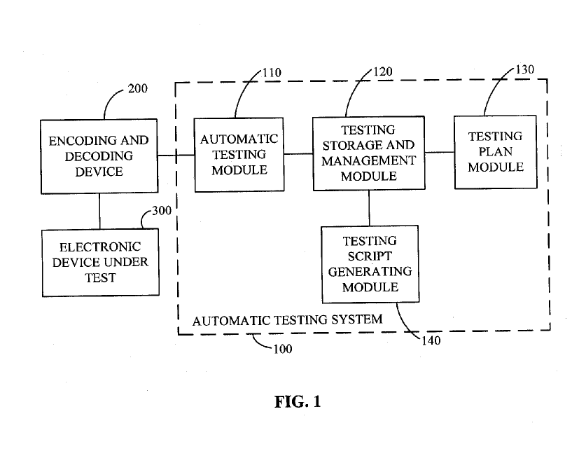

FIG. 1 is a block diagram of an automatic testing system 100 of an exemplary embodiment of the present invention, showing with an encoding and decoding device 200 and an electronic device 300 to be tested. The encoding and decoding device 200 is used for encoding information from the electronic device 300 and decoding information from the automatic testing system 100. In the exemplary embodiment, the automatic testing system 100 tests the information of the electronic device 300 encoded by the encoding and decoding device 200. In other exemplary embodiments of the present invention, the automatic testing system 100 tests the electronic device 300 directly.

The automatic testing system 100 includes an automatic testing module 110, a testing storage and management module 120, a testing plan module 130, and a testing script generating module 140.

The testing plan module 130 is used for receiving a testing plan provided by a tester, user or operator, and for automatically saving the testing plan in the testing storage and management module 120. In the exemplary embodiment, the tester inputs the testing plan into the testing plan module 130 according to a specification of the electronic device 300 under test. The testing plan includes a plurality of testing items. Each testing item of the testing plan corresponds to one function of the electronic device 300. In the exemplary embodiment, the testing plan is an Excel document.

The testing script generating module 140 is used for generating testing scripts according to the testing plan saved in the testing storage and management module 120, and for saving the testing scripts in the testing storage and management module 120. The testing script generating module 140 is started by the tester. If the testing script generating module 140 is started, the testing scripts will be automatically generated. Each testing script corresponds to one testing item of the testing plan; that is, one function of the electronic device 300 is tested with each testing script used. In other exemplary embodiments of the present invention, the testing script generating module 140 can also generate anticipated results according to the testing plan saved in the testing storage and management module 120, and automatically save the anticipated results in the testing storage and management module 120. Each anticipated result corresponds to one of the testing scripts, and the anticipated results are data related to normal operation of the electronic device 300 after running the testing scripts.

The automatic testing module 110 is used for reading at least one testing script saved in the testing storage and management module 120, and for automatically testing a function of the electronic device 300. In the exemplary embodiment, the automatic testing module 110 tests the information from the electronic device 300 encoded by the encoding and decoding device 200, and receives test data from the electronic device 300 via the encoding and decoding device 200. The automatic testing module 110 is also used for receiving the test data, and for automatically saving the test data in the testing storage and management module 120. In the exemplary embodiment, the test data generated by the electronic device 300 are analog signals, then the encoding and decoding device 200 encodes the analog signals when starting to test, and after encoding, the test data are changed from the analog signals into digital signals, and thus, the automatic testing module 110 automatically saves the encoded test data in the testing storage and management module 120. The automatic testing module 110 is started by the tester. When the automatic testing module 110 is started and the testing scripts are chosen, the automatic testing module 110 reads the testing scripts, and automatically tests the information of the electronic device 300.

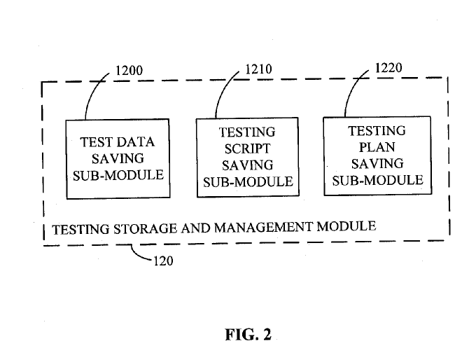

FIG. 2 is a block diagram of the testing storage and management module 120 of an exemplary embodiment of the present invention. The testing storage and management module 120 is used for saving the testing plan, the testing scripts, and the test data. The testing storage and management module 120 includes a test data saving sub-module 1200, a testing script saving sub-module 1210, and a testing plan saving sub-module 1220. The test data saving sub-module 1200 saves the test data from the electronic device 300 via the encoding and decoding device 200. The testing script saving sub-module 1210 saves the testing scripts generated by the testing script generating module 140. The testing plan saving sub-module 1220 saves the testing plan received by the testing plan module 130.

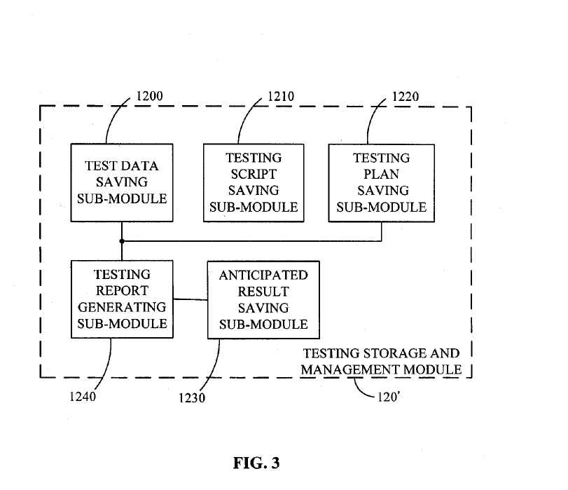

FIG. 3 is a block diagram of a testing storage and management module 120′ of another exemplary embodiment of the present invention. The testing storage and management module 120′ is not only used for saving the testing plan, the testing scripts, and the test data, but also used for saving the anticipated results generated by the testing script generating module 140 and for comparing the anticipated results with the test data to generate a testing report.

The testing storage and management module 120′ includes an anticipated result saving sub-module 1230 and a testing report generating sub-module 1240, besides the test data saving sub-module 1200, the testing script saving sub-module 1210, and the testing plan saving sub-module 1220. The anticipated result saving sub-module 1230 saves the anticipated results generated by the testing script generating module 140. The testing report generating sub-module 1240 compares the test data saved in the test data saving sub-module 1200 with the anticipated results saved in the anticipated result saving sub-module 1230, and generates the testing report based on the comparison. If the test data is consistent with the anticipated results, then the tested functions of the electronic device 300 pass; if the testing data is not consistent with the anticipated results, then the tested functions of the electronic device 300 do not pass. Accordingly, the electronic device 300 is normal if all tests are passed. In the exemplary embodiment, the testing report includes the testing items of the testing plan and the corresponding test results.

If the electronic device 300 is a mobile phone, all functions thereof are defined in a specification of the mobile phone. The tester inputs a testing plan into the testing plan module 130 according to the specification. The testing plan includes a plurality of testing items corresponding to the functions described in the specification. After the testing plan module 130 receives the testing plan, the testing script generating module 140 generates corresponding testing scripts according to the testing plan. The tester chooses the scripts for the function to be tested, such as testing scripts corresponding to functions of a monitor and a keyboard of the mobile phone, and starts the automatic testing module 110, the automatic testing module 110 will automatically read the chosen testing scripts, and automatically test the monitor and keyboard functions.

When the automatic testing system 100 tests the corresponding functions, the mobile phone generates corresponding test data. First, the encoding and decoding device 200 encodes the test data from the electronic device 300. Then the automatic testing module 110 saves the encoded test data in the test data saving sub-module 1200 of the testing storage and management module 120′. The testing storage and management module 120′ receives the encoded test data, and compares the encoded test data with the anticipated results saved in the anticipated result saving sub-module 1230 to generate the test results. Accordingly, the testing storage and management module 120′ generates the testing report including the testing plan and the test results.

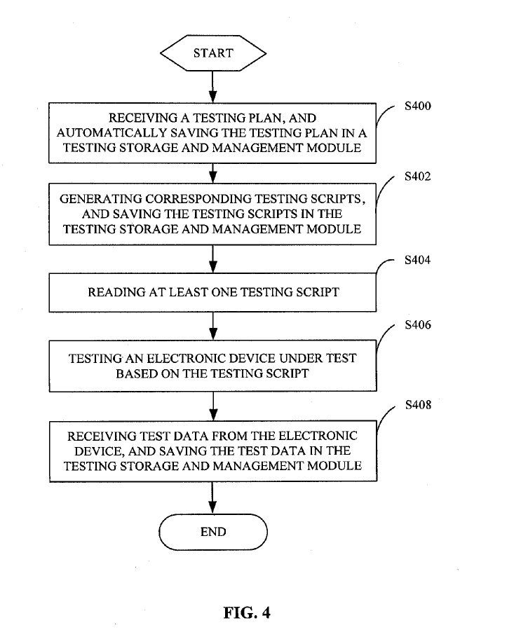

FIG. 4 is a flowchart of an automatic testing method in accordance with a further exemplary embodiment of the present invention. The tester inputs the testing plan according to the specification of the electronic device 300. In step S400, the testing plan module 130 receives the testing plan, and automatically saves the testing plan in the testing plan saving sub-module 1220 of the testing storage and management module 120. In step S402, the testing script generating module 140 generates the corresponding testing scripts according to the testing plan saved in the testing storage and management module 120, and saves the testing scripts in the testing script saving sub-module 1210 of the testing storage and management module 120. In step S404, the automatic testing module 110 reads at least one testing script from the testing storage and management module 120. The testing script is chosen by the tester, and the automatic testing module 110 automatically reads the chosen testing script. In step S406, the automatic testing module 110 automatically tests the electronic device 300 based on the testing script. In step S408, the automatic testing module 110 receives the test data from the electronic device 300 via the encoding and decoding device 200, and saves the test data in the testing data saving sub-module 1200 of the testing storage and management module 120, and thus, it is determined whether the electronic device 300 is normal or not according to the test data.

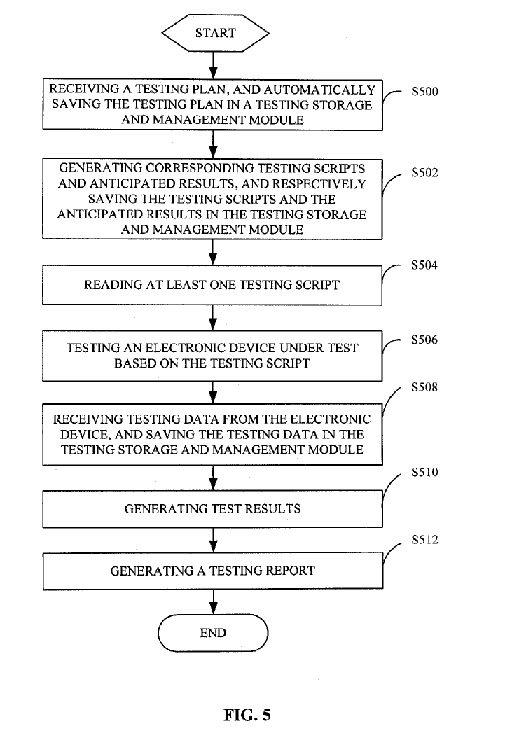

FIG. 5 is a flowchart of an automatic testing method in accordance with a still further exemplary embodiment of the present invention. The tester inputs the testing plan according to the specification of the electronic device 300. In step S500, the testing plan module 130 receives the testing plan, and automatically saves the testing plan in the testing plan saving sub-module 1220 of the testing storage and management module 120′. In step S502, the testing script generating module 140 generates the corresponding testing scripts and the anticipated results according to the testing plan saved in the testing storage and management module 120′, and respectively saves the testing scripts and the anticipated results in the testing script saving sub-module 1210 and the anticipated result saving sub-module 1230 of the testing storage and management module 120′. In step S504, the automatic testing module 110 reads at least one testing script saved in the testing storage and management module 120′. The testing script is chosen by the tester, and the automatic testing module 110 automatically reads the chosen testing scripts. In step S506, the automatic testing module 110 automatically tests the electronic device 300 based on the testing script.

In step S508, the automatic testing module 110 receives the test data from the electronic device 300 via the encoding and decoding device 200, and saves the test data in the test data saving sub-module 1200 of the testing storage and management module 120′. In step S510, the testing report generating sub-module 1240 compares the test data saved in the testing data saving sub-module 1200 with the anticipated results saved in the anticipated result saving sub-module 1230, and generates the test results. In the exemplary embodiment, if the test data is consistent with the anticipated results, then the tested functions of the electronic device 300 pass; if the test data is not consistent with the anticipated results, then the tested functions of the electronic device 300 don't pass. In step S512, the testing report generating sub-module 1240 generates the testing report according to the testing plan and the test results.

The automatic testing module 110 can read a plurality of testing scripts and test the electronic device 300 automatically. Accordingly, the automatic testing system 100 saves much time and manpower, and thus efficiency of the testing is improved.

While exemplary embodiments have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. An automatic testing system for testing an electronic device, comprising:
a testing plan module for receiving a testing plan;
a testing storage and management module for saving the testing plan;
a testing script generating module for generating testing scripts according to the testing plan, and for saving the testing scripts in the testing storage and management module; and
an automatic testing module for reading at least one testing script saved in the testing storage and management module, for automatically testing the electronic device, for receiving test data from the electronic device, and for saving the test data in the testing storage and management module.

2. The automatic testing system of claim 1, wherein the testing plan module automatically saves the testing plan in the testing storage and management module.

3. The automatic testing system of claim 1, wherein the testing script generating module is also used for generating anticipated results according to the testing plan saved in the testing storage and management module, and for saving the anticipated results in the testing storage and management module.

4. The automatic testing system of claim 3, wherein the anticipated results are data generated by running the testing scripts when the electronic device is normal.

5. The automatic testing system of claim 3, wherein the testing storage and management module is also used for comparing the anticipated results with the test data to generate test results and a testing report.

6. The automatic testing system of claim 5, wherein the testing storage and management module comprises:
a testing plan saving sub-module for saving the testing plan;
a testing script saving sub-module for saving the testing scripts; and
a testing data saving sub-module for saving the test data.

7. The automatic testing system of claim 6, wherein the testing storage and management module further comprises:
an anticipated result saving sub-module for saving the anticipated results; and
a testing report generating sub-module for comparing the test data with the anticipated results to generate the test results and the testing report.

8. The automatic testing system of claim 7, wherein the testing report comprises the testing plan and the test results.

9. The automatic testing system of claim 1, wherein the testing plan is an Excel document.

10. An automatic testing method for testing an electronic device, comprising steps of:
receiving a testing plan, and automatically saving the testing plan in a testing storage and management module;
generating corresponding testing scripts, and saving the testing scripts in the testing storage and management module;
reading at least one testing script from the testing storage and management module;
testing the electronic device based on the testing script; and
receiving test data from the electronic device, and saving the test data in the testing storage and management module.

11. The automatic testing method of claim 10, further comprising a step of:
generating corresponding anticipated results according to the testing plan, and saving the anticipated results in the testing storage and management module.

12. The automatic testing method of claim 11, wherein the anticipated results are data generated by running the testing scripts when the electronic device is normal.

13. The automatic testing method of claim 11, further comprising steps of:
generating test results; and
generating a testing report.

14. The automatic testing method of claim 13, wherein the step of generating test results comprises a step of:
comparing the test data with the anticipated results to generate the test results.

15. The automatic testing method of claim 14, wherein the step of generating a testing report comprises a step of:
generating the testing report according to the testing plan and the test results.

16. A method for automatically testing an electronic device, comprising steps of:
retrieving a testing plan definable and editable by users to test said electronic device;
generating corresponding testing scripts based on said retrieved testing plan;
retrieving at least one testing script selected from said generated corresponding testing scripts;
testing said electronic device by means of said selected at least one testing scripts based on said retrieved testing plan; and
retrieving test data from said electronic device resulting from said testing of said electronic device.

17. The method of claim 16, further comprising a step of saving respectively said retrieved testing plan, said generated corresponding testing scripts, and said retrieved test data.

18. The method of claim 16, further comprising a step of generating anticipated results corresponding to said testing scripts to show normal operation of said electronic device based on said testing plan.
